(19) United States
(12) Patent Application Publication
(10) Pub. No.: US 2007/0277139 A1
(43) Pub. Date: Nov. 29, 2007

(54) Semiconductor Integrated Circuit and Designing Method of the Same, and Electronic Apparatus Using the Same

(75) Inventor: Yoshiyuki Kurokawa, Kanagawa (JP)

Correspondence Address: NIXON PEABODY, LLP, 401 9TH STREET, NW, SUITE 900, WASHINGTON, DC, 20004-2128, US

(73) Assignee: SEMICONDUCTOR ENERGY LABORATORY CO., LTD., ATSUGI-SHI, KANAGAWA-KEN (JP)

(21) Appl. No.: 11/663,447

(22) PCT Filed: Oct. 7, 2005
(86) PCT No.: PCT/JP05/18902

§ 371 Date: Mar. 22, 2007

(30) Foreign Application Priority Data
Oct. 13, 2004 (JP) 2004-298352

(51) Int. Cl. G06F 17/50

(52) U.S. Cl. 716/12

(57) ABSTRACT

A designing method of a semiconductor integrated circuit, by which a semiconductor integrated circuit with a small amount of wire routing, a small layout area and low wire capacitance can be achieved effectively. The designing method of the semiconductor integrated circuit of the invention has a logic synthesis step of generating a first netlist that defines the connection between standard cells stored in a cell library based on the specifications of the semiconductor integrated circuit, a cell composition step of analyzing the first netlist to extract a combination of standard cells, which satisfies predetermined criteria, of composing the extracted combination of standard cells to store it as a new standard cell in the cell library, and of rewriting the first netlist using the new standard cell to generate a second netlist, and a step of performing automatic placement and routing based on the second netlist.

### TECHNICAL FIELD

The present invention relates to a semiconductor integrated circuit and a designing method thereof. In particular, the invention relates to a semiconductor integrated circuit where automatic placement and routing is performed using a standard cell, and to a designing method thereof. Further, the invention relates to an electronic apparatus using such a semiconductor integrated circuit.

### BACKGROUND ART

Known is a designing method of a semiconductor integrated circuit, where a cell library that stores circuit components such as logic gates, flip flops or combinations of them as standard cells (also simply referred to as cells) is prepared and these cells are arbitrarily placed and connected to achieve desired functions (specifications) (see Patent Document 1). FIG. 1 is a flow chart showing an example of such a conventional designing method of a semiconductor integrated circuit.

As shown in FIG. 1, first, functional design or specification description of a semiconductor integrated circuit is performed using HDL (Hardware Description Language) in step 1. Then, in step 2, a netlist 254 is generated, which defines the connection between cells stored in a cell library 250 to realize the function described in HDL (this step is referred to as logic synthesis). In the logic synthesis, with reference mainly to timing information 251 and logic information 252 of each cell, which are stored in the cell library 250, the cells are selected and connected so that desired functions are realized and a delay time calculated from the timing information 251 satisfies predetermined criteria. By changing the cell library 250 to be used, the circuit having the same specifications can be realized in different modes. In step 3, the cells are placed and routed based on the netlist 254. This step is called placement and routing, and performed herein with reference mainly to layout information 253 that is stored in the cell library 250 and represents the position of input and output terminals of the cells. In step 4, a photomask used in manufacturing steps of the semiconductor integrated circuit is formed to realize the placement and routing of the cells determined in step 3. Note that the logic synthesis in step 2 and the placement and routing in step 3 can be automatically performed with tools (automatic logic synthesis, automatic placement and routing).

FIG. 2 is a circuit diagram showing an example of a part of a semiconductor integrated circuit. In the netlist, as is well known, such a circuit as shown in FIG. 2 is described in text as the connection between cells. The circuit shown in FIG. 2 includes as circuit components flip flops 1 to 4, NAND gates 5 to 8, NOR gates 9 to 11, and inverters 12 and 13. Standard cells corresponding to these circuit components are stored in the cell library 250. A plurality of cells corresponding to one circuit component may be stored in the cell library 250, which are for high voltage usage, low power consumption usage and the like, and may be arbitrarily selected to be used. In fact, the semiconductor integrated circuit can include millions of circuit components (i.e., cells).

FIG. 3 is a schematic plan view showing the result of automatic placement and routing of the standard cells based on the circuit diagram shown in FIG. 2. In FIG. 3, each cell is a rectangle with the same height and the position of input and output terminals (also referred to as nodes) thereof is determined. In FIG. 3, cells 101 to 104 correspond to the flip flops 1 to 4 in FIG. 2, cells 105 to 108 correspond to the NAND gates 5 to 8 in FIG. 2, cells 109 to 111 correspond to the NOR gates 9 to 11 in FIG. 2, and cells 112 and 113 correspond to the inverters 12 and 13 in FIG. 2. Predetermined logic functions and the like are realized by transistors, resistors and the like in the actual standard cells, though FIG. 3 uses circuit symbols for simplicity.

In the case of such automatic placement and routing, wire capacitance increases when the amount of wire routing for connecting nodes of cells increases. The increase in wire capacitance may cause reduction in operating frequency of a semiconductor integrated circuit, increase in power consumption, and the like. In addition, the layout area of the semiconductor integrated circuit increases due to a large amount of wire routing. However, the wire routing is difficult to be optimized with an automatic placement and routing tool, which may be required to be optimized manually, though such manual optimization has limitations in terms of operating efficiency. In general, unnecessary wire routing tends to increase with increase in circuit scale; therefore, in the case of producing a large scale semiconductor integrated circuit including millions of cells or more, manual optimization is practically impossible.

Various methods have been disclosed to reduce the layout area (or chip area) of a semiconductor integrated circuit as much as possible (see Patent Documents 2 to 7), though they are not considered to be sufficient in terms of reduction in wire routing, efficiency (facility) of the process thereof, and the like.
[Patent Document 1] Japanese Patent Laid-Open No. 7-94586
[Patent Document 2] Japanese Patent Laid-Open No. 6-85064
[Patent Document 3] Japanese Patent Laid-Open No. 6-188312
[Patent Document 4] Japanese Patent Laid-Open No. 6-209044
[Patent Document 5] Japanese Patent Laid-Open No. 8-63515
[Patent Document 6] Japanese Patent Laid-Open No. 10-4141
[Patent Document 7] Japanese Patent Laid-Open No. 2000-307007

### DISCLOSURE OF INVENTION

It is a primary object of the invention to provide a designing method of a semiconductor integrated circuit, by which a semiconductor integrated circuit with a small amount of wire routing, a small layout area and low wire capacitance (i.e., with high operating frequency and low power consumption) can be achieved effectively.

It is another object of the invention to provide a semiconductor integrated circuit with a small amount of wire routing, a small layout area and low wire capacitance, as well as a low price, small size and low power consumption electronic apparatus having such a semiconductor integrated circuit.

In order to solve the aforementioned problems, the invention provides a designing method of a semiconductor integrated circuit, which has a logic synthesis step of generating a first netlist that defines the connection between standard cells stored in a cell library based on the specifications of the semiconductor integrated circuit, a cell composition step of analyzing the first netlist generated in the logic synthesis step to extract a combination of standard cells, which satisfies predetermined criteria, of composing the extracted combination of standard cells to store it as a new standard cell in the cell library, and of rewriting the first netlist using the new standard cell to generate a second netlist, and a step of performing automatic placement and routing based on the second netlist.

The cell composition step preferably has a step of detecting combinations of standard cells where a first output terminal of a first standard cell is connected only to first input terminals of second to n-th (n is a natural number of two or more) standard cells, and selecting a combination that occurs a predetermined number of times or more from the detected combinations of standard cells as a combination to be composed. For example, if n=2 is satisfied, the first and second standard cells are composed to be a new standard cell.

The combination of standard cells to be composed is preferably selected from standard cells on a critical path.

In the cell composition step, composition is preferably not performed in the case where the layout area of the standard cell after the composition is larger than a predetermined area.

In addition, it is preferable that each of the standard cells stored in the cell library have a cell composition terminal on a side in contact with an adjacent standard cell separately from a common wiring terminal, and a new standard cell is formed by connecting the cell composition terminals of the standard cells to be composed.

In the cell composition step, a wiring layer included in a new standard cell, which connects terminals of standard cells to be composed, may be formed separately from a wiring layer for connecting common standard cells.

According to another mode of the invention, provided is a designing method of a semiconductor integrated circuit, which has a logic synthesis step of generating a netlist that defines the connection between standard cells stored in a cell library based on the specifications of the semiconductor integrated circuit, a step of analyzing the netlist generated in the logic synthesis step to extract a combination of standard cells, which satisfies predetermined criteria, and a step of performing automatic placement and routing based on the netlist so that standard cells included in the extracted combination of standard cells are adjacent to each other.

If an electronic apparatus has a display portion, the aforementioned designing method of a semiconductor integrated circuit may be applied to a semiconductor integrated circuit used for a functional circuit (e.g., CPU, image processing circuit, memory and the like) of the display portion. The functional circuit of the display portion is preferably constituted by thin film transistors (TFTs) over the same substrate as the display portion.

According to another mode of the invention, provided is a semiconductor integrated circuit having a composite cell formed by combining two or more standard cells that correspond to predetermined circuit components, wherein the composite cell has an additional wire for arbitrarily connecting the circuit components, which is not included in each of the two or more standard cells.

The additional wire in the composite cell may be formed on a different layer than wires included in the two or more standard cells to be combined. Alternatively, in the composite cell, a part of the wires included in the two or more standard cells to be combined may be removed so that the additional wire is not interrupted.

According to another mode of the invention, provided is a semiconductor integrated circuit having a composite cell formed by combining two or more standard cells that correspond to predetermined circuit components, wherein each of the two or more standard cells has a cell composition terminal on a side in contact with an adjacent standard cell separately from a common wiring terminal, and in the composite cell, the circuit components included in the two or more standard cells are connected using the cell composition terminal.

According to another mode of the invention, provided is a semiconductor integrated circuit having a composite cell formed by combining two or more standard cells that correspond to predetermined circuit components, wherein in the composite cell, the pattern of one of the two or more standard cells partially overlaps the pattern of another standard cell.

The area of the composite cell is preferably smaller than the total area of the two or more standard cells to be composed, and the semiconductor integrated circuit preferably includes a plurality of composite cells.

According to another mode of the invention, provided is an electronic apparatus using the aforementioned semiconductor integrated circuit. If the electronic apparatus has a display portion, the semiconductor integrated circuit may be used for a functional circuit of the display portion of the electronic apparatus. The functional circuit is preferably constituted by TFTs over the same substrate as the display portion.

According to the designing method of a semiconductor integrated circuit of the invention, after a first netlist is generated, a predetermined combination of standard cells is composed by analyzing the first netlist and stored as a new standard cell in a cell library. Then, the first netlist is rewritten using the new standard cell to generate a second netlist, and automatic placement and routing is performed. Such cell composition allows the number of standard cells included in the netlist to be reduced; therefore, the number of wires for connecting cells can be reduced and the total wire capacitance can be significantly reduced. Reduction in the number of standard cells and wires leads to reduction in unnecessary routing that occurs when routing is performed with an automatic placement and routing tool. Accordingly, optimization can be performed effectively and designing time can be significantly reduced. Reduction in wire capacitance results in a semiconductor integrated circuit with lower power consumption, higher operating frequency, and higher performance.

In the cell composition step, combinations of standard cells where a first output terminal of a first standard cell is connected only to first input terminals of second to n-th (n is a natural number of two or more) standard cells are detected, and a combination that occurs a predetermined number of times or more is selected as a combination to be composed from the detected combinations of standard cells, thereby a combination of cells, which has a significant effect of reducing wire routing due to composition, can be extracted effectively.

When the combination of standard cells to be composed is selected from standard cells on a critical path, operating frequency in the critical path can be improved and a higher performance semiconductor integrated circuit can be obtained effectively.

In the cell composition step, when composition is not performed in the case where the layout area of the standard cell after the composition is larger than a predetermined area, it can be prevented that routing is performed by bypassing a large cell and that unnecessary wire routing increases.

When each of the standard cells stored in the cell library has a cell composition terminal on a side in contact with an adjacent standard cell separately from a common wiring terminal, and a new standard cell is formed by connecting the cell composition terminals of the standard cells to be composed, connection between such cell composition terminals can be automatically performed with a layout tool and a new standard cell can be easily formed. As a result, routing that has been performed outside the cell can be performed inside the new standard cell, leading to significant reduction in wire routing and reduction in wire capacitance and layout area.

In the cell composition step, when a wiring layer included in a new standard cell, which connects terminals of standard cells to be composed, is formed separately from a wiring layer for connecting common standard cells, the new standard cell can be easily formed by connecting terminals of the cells to be composed even if it is difficult to provide a cell composition terminal in each cell. As a result, routing that has been performed outside the cell can be performed inside the new standard cell, leading to significant reduction in wire routing and reduction in wire capacitance and layout area.

According to the designing method of a semiconductor integrated circuit in accordance with another mode of the invention, predetermined combinations of standard cells are placed to be adjacent to each other in placement and routing, thereby the length of wires can be made shorter, and wire capacitance and layout area can be reduced as compared to the case where the combinations of cells are not adjacent to each other.

In an electronic apparatus having a semiconductor integrated circuit, when the semiconductor integrated circuit is designed in accordance with the aforementioned designing method of a semiconductor integrated circuit, wire routing of the semiconductor integrated circuit can be reduced and wire capacitance and layout area can also be reduced; thus an electronic apparatus with low price, small size, low power consumption, and high performance (high operating frequency) can be provided. In particular, when the electronic apparatus has a display portion and a semiconductor integrated circuit is used for a functional circuit of the display portion of the electronic apparatus, the electronic apparatus can have a display portion with low price, thin shape, low power consumption, and high definition. In addition, when such a functional circuit is constituted by thin film transistors (TFTs) over the same substrate as the display portion, it becomes much easier to provide the electronic apparatus having the display portion with low price, thin shape, low power consumption, and high definition.

In the semiconductor integrated circuit in accordance with the invention, the composite cell formed by combining two or more standard cells has an additional wire for arbitrarily connecting circuit components, which is not included in each of the two or more standard cells to be composed. Accordingly, routing that has been performed outside the cell can be performed inside the cell, leading to significant reduction in wire routing and reduction in wire capacitance and layout area.

When the additional wire in the composite cell is formed on a different layer than wires included in the two or more standard cells to be composed, the additional wire can be prevented from interrupting the wires included in the standard cells to be composed. Alternatively, when removing a part of the wires included in the two or more standard cells to be composed, the additional wire can be prevented from being interrupted.

According to another semiconductor integrated circuit in accordance with the invention, in the composite cell, cell composition terminals in the two or more standard cells to be composed are used for connection between circuit components included in those standard cells. As a result, routing that has been performed outside the cell can be performed inside the cell, leading to significant reduction in wire routing and reduction in wire capacitance and layout area.

According to another semiconductor integrated circuit in accordance with the invention, in the composite cell, the pattern of one of the two or more standard cells to be composed partially overlaps the pattern of another standard cell. Therefore, the area of the composite cell can be made much smaller than the total area of the two or more standard cells to be composed, and thus the layout area of the semiconductor integrated circuit can be significantly reduced.

When the semiconductor integrated circuit uses a plurality of the aforementioned composite cells, wire routing, wire capacitance and layout area can be reduced more effectively.

When the aforementioned semiconductor integrated circuit is used for an electronic apparatus, the electronic apparatus with low price, small size, low power consumption, and high performance (high operating frequency) can be provided. In particular, when the electronic apparatus has a display portion and a semiconductor integrated circuit is used for a functional circuit of the display portion, the electronic apparatus can have the display portion with low price, thin shape, low power consumption, and high definition. In addition, when such a functional circuit is constituted by thin film transistors (TFTs) over the same substrate as the display portion, it becomes much easier to provide the electronic apparatus having the display portion with low price, thin shape, low power consumption, and high definition.

### BRIEF DESCRIPTION OF DRAWINGS

FIG. 1 is a flow chart showing an example of a conventional designing method of a semiconductor integrated circuit.

FIG. 2 is a circuit diagram showing an example of a part of a semiconductor integrated circuit.

FIG. 3 is a schematic plan view showing the result of automatic placement and routing of standard cells based on the circuit diagram shown in FIG. 2.

FIG. 4 is a flow chart showing a first preferred embodiment mode of a designing method of a semiconductor integrated circuit in accordance with the invention.

FIG. 5 is a flow chart specifically showing a cell composition step in FIG. 4.

FIG. 6 is a schematic plan view showing an example of a cell layout obtained by applying the designing method of a semiconductor integrated circuit shown in FIGS. 3 and 4 to the circuit diagram shown in FIG. 2.

FIGS. 7A to 7E are schematic views each showing a preferred embodiment of a standard cell suitable for composition.

FIG. 8A is a schematic view showing connection between a NAND gate and an inverter, and FIG. 8B is a circuit diagram showing an example of a circuit for realizing the NAND gate and the inverter.

FIGS. 9A and 9B are schematic plan views showing examples of a standard cell for a NAND gate, and FIG. 9C is a schematic plan view showing an example of a standard cell for an inverter.

FIGS. 10A and 10B are schematic plan views showing examples of a composite cell corresponding to a combination of the NAND gate and the inverter shown in FIGS. 8A and 8B.

FIG. 11 is a flow chart showing a second embodiment mode of a designing method of a semiconductor integrated circuit in accordance with the invention.

FIG. 12 is a schematic view showing an example of a cell layout obtained by applying the designing method of a semiconductor integrated circuit shown in FIG. 11 to the circuit diagram shown in FIG. 2.

FIGS. 13A to 13H are perspective views showing electronic apparatuses to which the invention is applied.

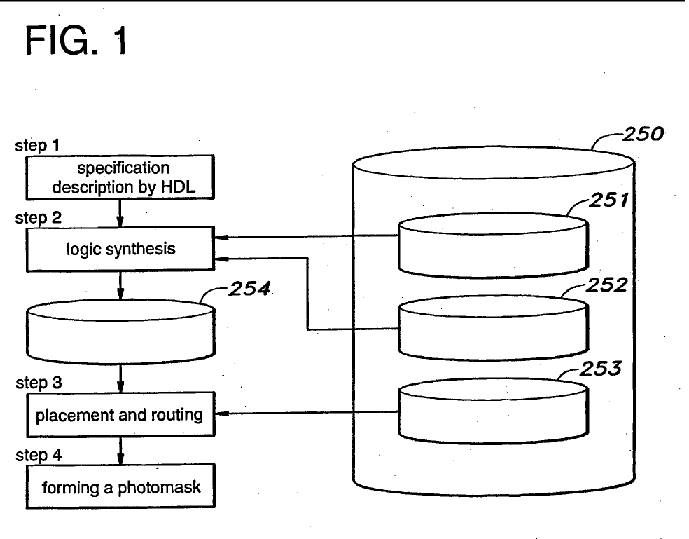

### BEST MODE FOR CARRYING OUT THE INVENTION

Embodiment Modes of the invention are hereinafter described with reference to the accompanying drawings.

### Embodiment Mode 1

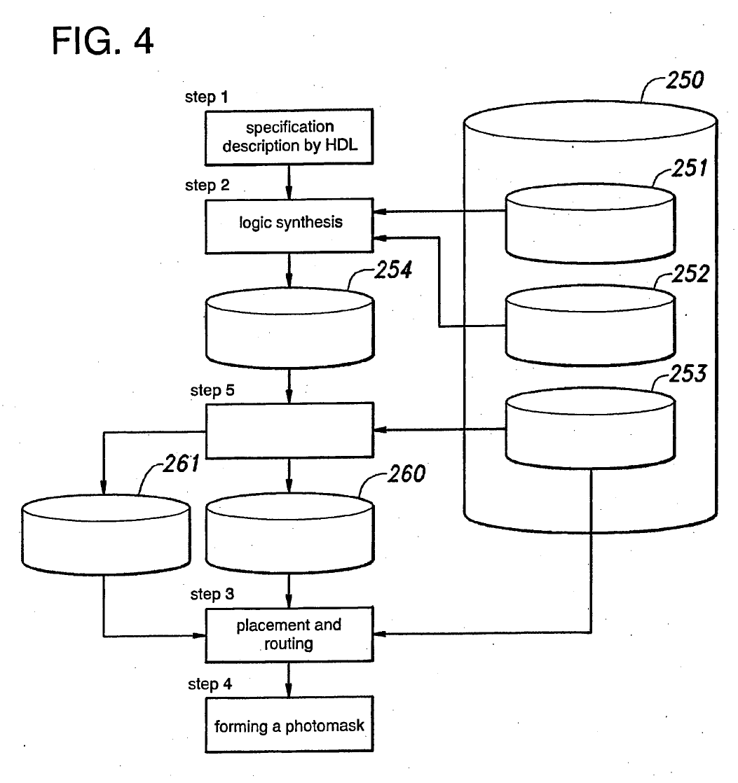

FIG. 4 is a flow chart showing a first embodiment mode of a designing method of a semiconductor integrated circuit in accordance with the invention. Note that in this specification, the semiconductor integrated circuit means an integrated circuit constituted by circuit elements including semiconductor elements (such as a MOS transistor), and it may be formed over an IC chip (such as an LSI chip and a VLSI chip) using a single crystalline silicon substrate, or it may be constituted by thin film transistors formed over an insulating substrate such as a glass substrate. In this embodiment mode, as shown in FIG. 4, functional design of a semiconductor integrated circuit is performed using HDL (Hardware Description Language) in step 1 similarly to the conventional designing method. Then, in step 2, logic synthesis is performed using standard cells stored in the cell library 250, and the netlist (first netlist) 254 is generated.

In this embodiment mode, before the placement and routing in step 3, cell composition (or synthesis) is performed in step 5, where a combination of cells (circuit components) that satisfies predetermined criteria is extracted from the netlist 254 generated in step 2, and the extracted combination of cells is added as a new standard cell (called a composite cell) to the cell library 250. In this cell composition step, a composite cell netlist (second netlist) 260 using the composite cell, and composite cell layout information 261 are generated.

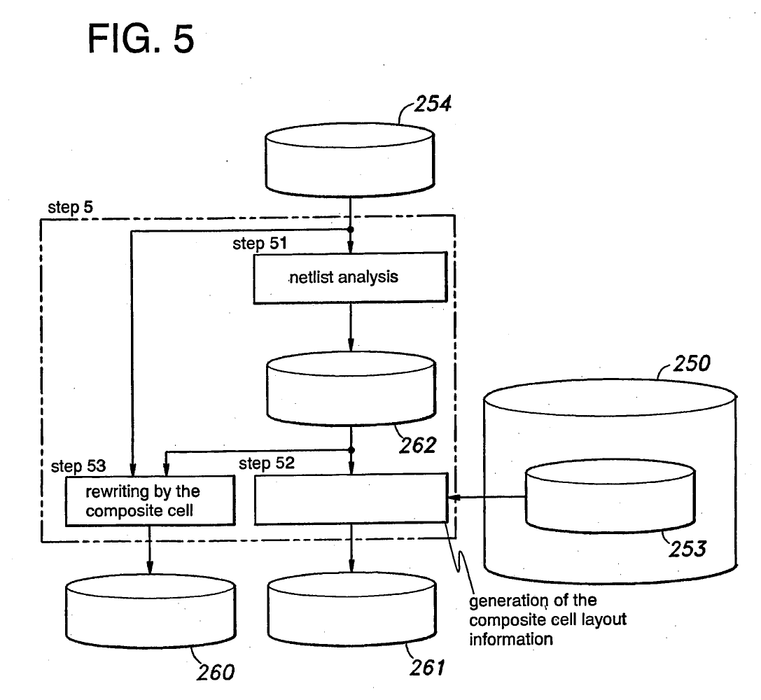

The cell composition step in step 5 is shown more specifically in FIG. 5. As shown in FIG. 5, the first netlist 254 generated by the logic synthesis in step 2 is analyzed in step 51 to extract a combination of standard cells to be composed. This step may be performed, for example, by detecting combinations of standard cells where a first output terminal of a standard cell is connected only to a first input terminal of another standard cell, and selecting a combination that occurs a predetermined number of times or more (namely, a combination with high frequency of occurrence) from the detected combinations of standard cells. More generally, a combination of standard cells to be composed may be extracted by detecting combinations of standard cells where a first output terminal of a first standard cell is connected only to first input terminals of second to n-th (n=2) standard cells, and selecting a combination that occurs a predetermined number of times or more (if n=2 is satisfied, a combination has only two standard cells) from the detected combinations of standard cells. Standard cells on a critical path, which considerably influence the performance (operating frequency) of the semiconductor integrated circuit, may be preferentially extracted as a combination of cells to be composed. The standard cells on a critical path can be extracted in the logic synthesis, and they are thus not required to be rechecked. Note that the number of standard cells to be composed is not limited to two, and three or more standard cells may be composed.

In the netlist analysis in step 51, information (composite cell information 262) on the extracted combination of standard cells, such as the kind of the standard cells, connection state of terminals of each standard cell, and terminal information after the composition, is extracted from the netlist 254. At this time, the area of the composite cell may be calculated and composition may be canceled if the area of the composite cell exceeds a predetermined value. This is because when the cell is too large, wire routing is performed in the automatic placement and routing by bypassing the cell, which increases unnecessary wires.

In step 52, the composite cell layout information 261 is generated from the obtained composite cell information 262 and the standard cell layout information 253 that is stored in the cell library 250 in advance. Note that if there are a plurality of combinations of cells to be composed, a plurality of pieces of composite cell information 262 and composite cell layout information 261 are generated.

The composite cell information 262 and the composite cell layout information 261 are stored in the cell library 250, thereby the composite cell is stored as a new standard cell in the cell library 250.

In step 53, a corresponding combination of standard cells in the netlist 254 is substituted by the composite cell while referring to the composite cell information 262, and the composite cell netlist (second netlist) 260 is generated.

The aforementioned netlist analysis in step 51 is basically lexical analysis, and may be automatically performed by computer. Generation of the composite cell layout information 261 in step 52 may also be automatically performed with a common layout tool. In addition, generation of the composite cell netlist 260 in step 53 is basically character string substitution operations, and automatically performed by computer with ease. In this manner, each of the cell composition steps can be performed quite effectively by computer, and the designing time does not increase so much.

Reference is made to FIG. 4 again. In step 3, automatic placement and routing is performed while referring to the layout information 253 included in the cell library 250 and the composite cell layout information 261 generated in step 5. In step 4, similarly to the conventional designing step, a photomask used in manufacturing steps of the semiconductor integrated circuit is formed to achieve the placement and routing of cells determined in step 3. Note that the cell composition step in step 5 may be performed repeatedly, and in that case, the composite cell that has been generated may further be combined with another standard cell.

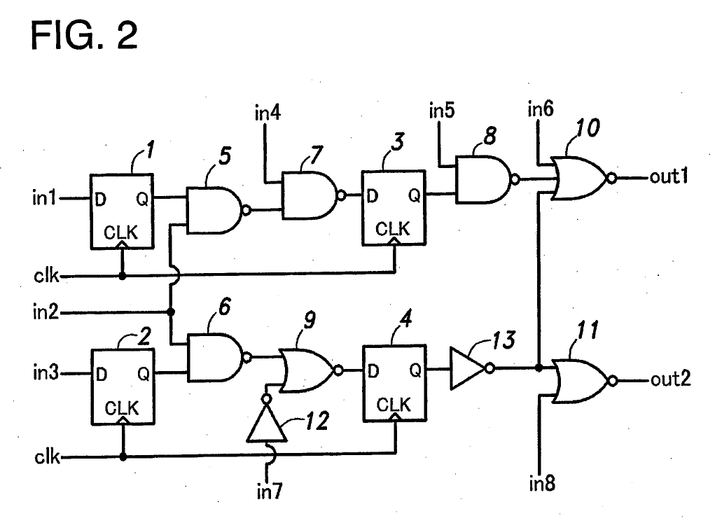

Described hereinafter is a case where such a designing method of a semiconductor integrated circuit in accordance with the first embodiment mode of the invention is applied to the circuit shown in FIG. 2. In FIG. 2, an output terminal of the flip flop 1 is connected to an input terminal of the NAND gate 5, and such a connection is also applied to a combination of the flip flop 2 and the NAND gate 6, and a combination of the flip flop 3 and the NAND gate 8 (that is, the same combination of cells occurs three times). Thus, a combination of cells corresponding to the flip flop and the NAND gate is extracted as a combination of cells to be composed, and stored as a new standard cell in the cell library 250 (steps 51 and 52). In addition, the netlist 254 is rewritten using the new standard cell to generate the composite cell netlist 260 (step 53).

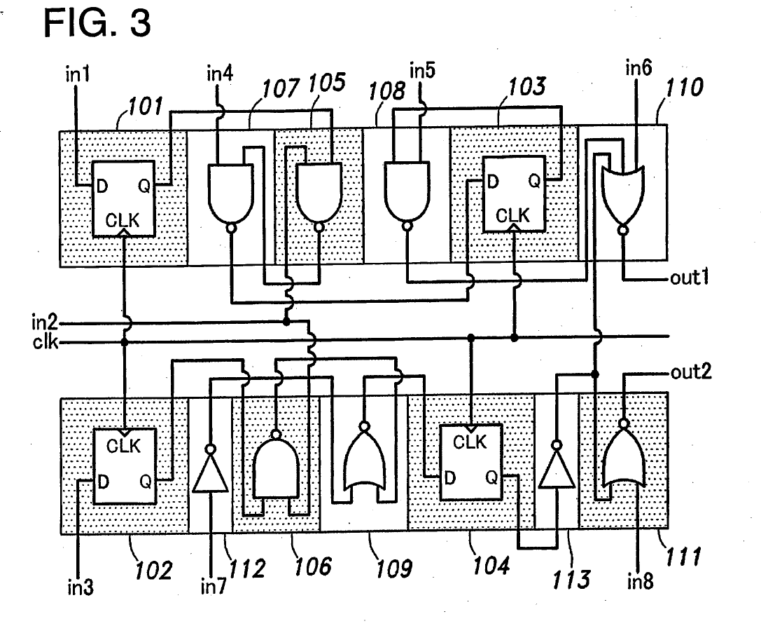

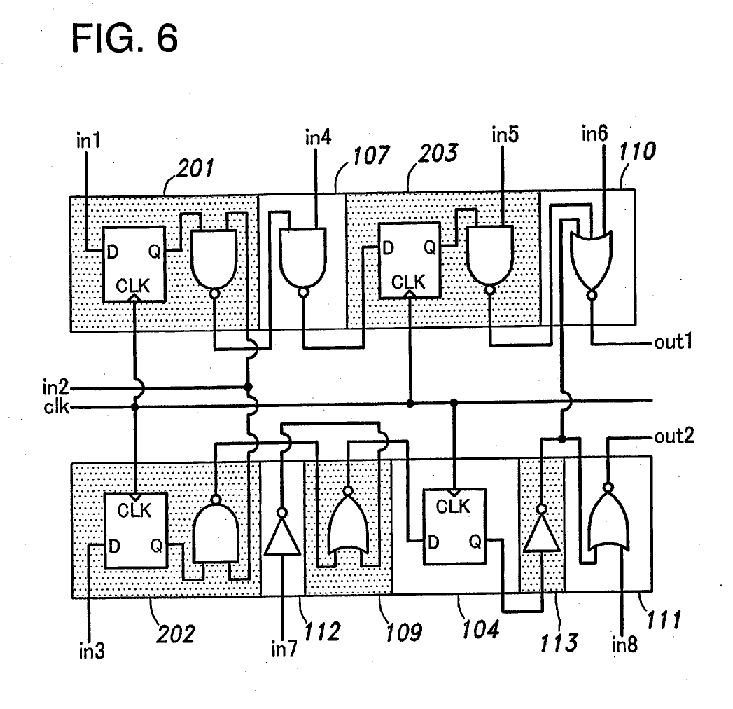

FIG. 6 is a schematic plan view showing an example of a cell layout that is obtained by automatic placement and routing in accordance with the composite cell netlist 260 where the combination of the flip flop and the NAND gate is substituted by the composite cell as described above. In FIG. 6, the same cell as that in FIG. 3 is denoted by the same reference numeral. In the cell layout shown in FIG. 6, the combination of the flip flop 101 and the NAND gate 105 in FIG. 3 is substituted by a composite cell 201, the combination of the flip flop 102 and the NAND gate 106 is substituted by a composite cell 202, and the combination of the flip flop 103 and the NAND gate 108 is substituted by a composite cell 203.

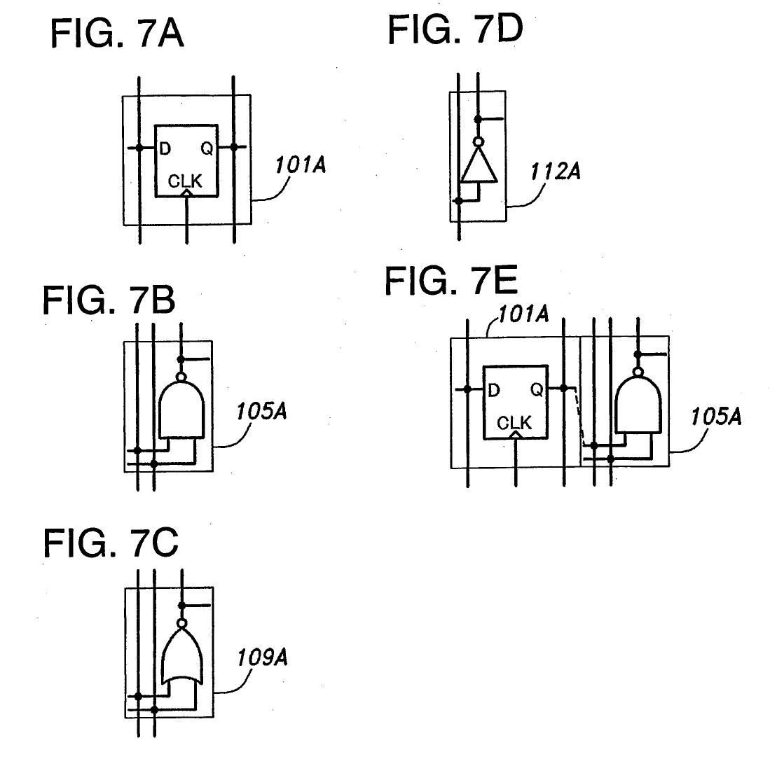

FIGS. 7A to 7D are schematic views showing preferred embodiments of a standard cell suitable for the aforementioned cell composition. In a flip flop cell 101A shown in FIG. 7A, in addition to common cell wiring terminals on the upper and lower sides, input and output terminals connected to adjacent cells in the cell composition are provided so as to be close to the right and left sides in contact with the adjacent cells (in this embodiment, the input and output terminals are provided on the left and right sides respectively, though the input and output terminals may be provided on the right and left sides respectively). Similarly, in a NAND gate cell 105A shown in FIG. 7B, a NOR gate cell 109A shown in FIG. 7C, and an inverter cell 112A shown in FIG. 7D, input and output terminals are provided on the left and right sides respectively, in addition to common cell wiring input and output terminals on the upper and lower sides. When each cell thus has input and output terminals used for the cell composition on a predetermined position of the right and left sides, in the generation of composite cell layout information (i.e., in the generation of composite cell), the input terminal of one of the cells to be composed may be, for example, automatically connected to the output terminal of the other with a layout tool as shown by a dashed line in FIG. 7E. Accordingly, automation with layout tools is facilitated.

In the generation of composite cell layout information, a wiring layer included in a new standard cell, which connects terminals of standard cells to be composed, is preferably formed separately from a wiring layer provided outside standard cells, which connects the common standard cells. According to this, cells can be composed easily even when the cell composition terminals as shown in FIGS. 7A to 7D are difficult to be provided in each cell. As a result, in the composite cells 201, 202 and 203, for example, the flip flop and the NAND gate are connected in the cell without requiring an external wire. Thus, wire routing can be drastically reduced and wire capacitance and the layout area of the integrated circuit can be reduced. In addition, the layout area of each of the composite cells 201, 202 and 203 can be made smaller than the total area of the flip flop cell (e.g., the cell 101 in FIG. 3) and the NAND gate cell (e.g., the cell 105 in FIG. 3) that have not been composed, leading to reduction in layout area of the entire semiconductor integrated circuit. As set forth above, all the cell composition steps can be performed quite effectively by computer, and the designing time does not increase so much. Further, the use of the composite cells 201, 202 and 203 reduces the number of standard cells included in the netlist 260 and the number of wires between cells, as well as the occurrence of unnecessary routing in automatic placement and routing with tools; therefore, wire capacitance can be manually reduced with ease, which results in considerable improvement in design efficiency. In this manner, according to the invention, the semiconductor integrated circuit with a small amount of wire routing, a small layout area and low wire capacitance (i.e., with high operating frequency and low power consumption) can be achieved effectively.

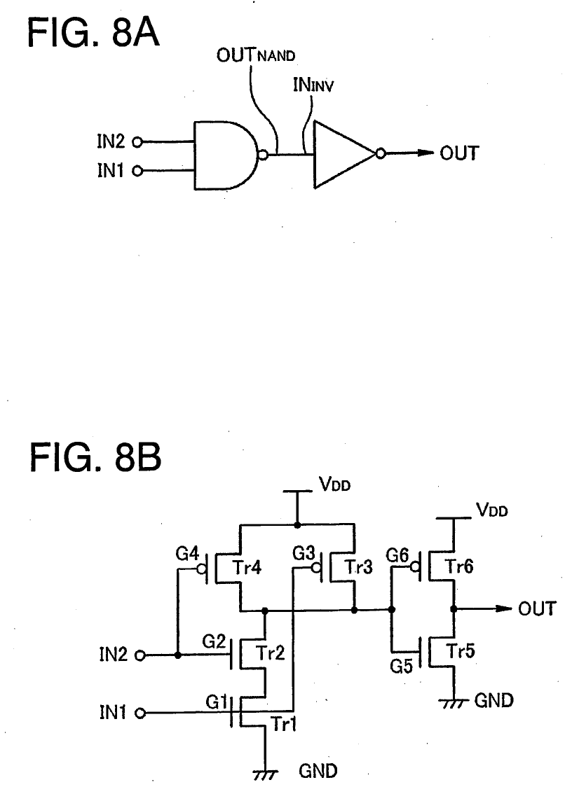

The composite cell in accordance with the invention is more specifically described taking as an example a combination of a NAND gate and an inverter shown in FIG. 8A. FIG. 8B is a circuit diagram showing an example of a circuit for realizing a connection between the NAND gate and the inverter shown in FIG. 8A. As shown in FIGS. 8A and 8B, the NAND gate has two N-type transistors (MOSFETS) Tr1 and Tr2 that are connected in series, and two P-type transistors (MOSFETS) Tr3 and Tr4 that are connected in parallel. A first input terminal IN1 is connected to gates G1 and G3 of the N-type transistor Tr1 and the P-type transistor Tr3 respectively, while a second input terminal IN2 is connected to gates G2 and G4 of the N-type transistor Tr2 and the P-type transistor Tr4 respectively. Sources of the P-type transistors Tr3 and Tr4 are connected to a high level power supply potential VDD, and drains thereof are connected to a drain of the N-type transistor Tr2 and an output terminal OUT_{NAND}. The output terminal OUT_{NAND} is connected to an input terminal IN_{INV}. Further, a source of the N-type transistor Tr2 is connected to a drain of the N-type transistor Tr1, and a source of the N-type transistor Tr1 is connected to a ground potential GND as a low level power supply potential. Such a NAND gate circuit is well known in this field.

The inverter has an N-type transistor Tr5 and a P-type transistor Tr6 that are connected in series. A source of the N-type transistor Tr5 is connected to the ground potential GND while a source of the P-type transistor Tr6 is connected to the high level power supply potential VDD. The input terminal IN_{INV} is connected to gates G5 and G6 of these transistors Tr5 and Tr6. An output terminal OUT is connected to a node (drain) between these transistors Tr5 and Tr6. Such an inverter circuit is well known in this field.

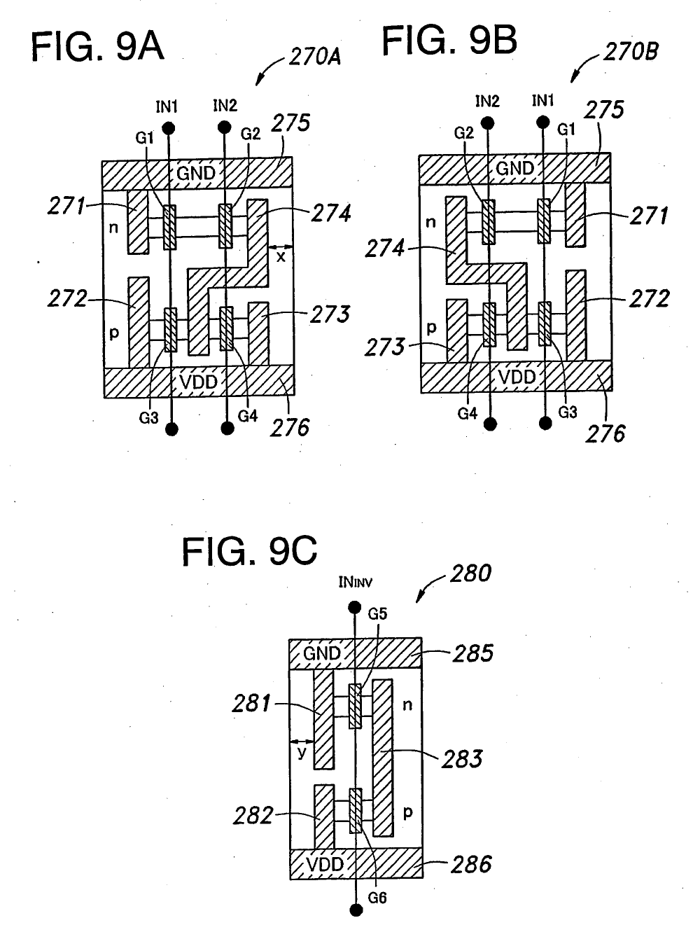

The NAND gate circuit shown in FIG. 8B can be realized as a standard cell 270A in FIG. 9A or a standard cell 270B in FIG. 9B, for example.

A metal wire 275 to which the ground potential GND is supplied is provided on the upper side of the standard cell 270A shown in FIG. 9A, and a metal wire 276 to which the high level power supply potential VDD is supplied is provided on the lower side thereof. Impurities are doped so that the N-type transistors Tr1 and Tr2 connected in series are formed on the upper side in the drawing while the P-type transistors Tr3 and Tr4 connected in parallel are formed on the lower side. As described above, the first input terminal IN1 is connected to the gates G1 and G3 of the N-type transistor Tr1 and the P-type transistor Tr3, and the second input terminal IN2 is connected to the gates G2 and G4 of the N-type transistor Tr2 and the P-type transistor Tr4. Note that the first input terminal IN1 and the second input terminal IN2 are pulled to both the upper and lower sides, though they may be pulled to one of the upper and lower sides. The standard cell 270A also has a metal wire 271 for connecting the source of the N-type transistor Tr1 to the ground potential GND, metal wires 272 and 273 for connecting the sources of the P-type transistors Tr3 and Tr4 to the high level power supply potential VDD, and a metal wire 274 for connecting the drain of the N-type transistor Tr2 to the drains of the P-type transistors Tr3 and Tr4. Note that the output terminal OUT_{NAND} is connected to the metal wire 274, though it is not shown in the drawing for simplicity.

The standard cell 270B shown in FIG. 9B is symmetrical to the standard cell 270A shown in FIG. 9A.

The inverter circuit shown in FIG. 8B can be realized as a standard cell 280 in FIG. 9C, for example. A metal wire 285 to which the ground potential GND is supplied is provided on the upper side of the standard cell 280, and a metal wire 286 to which the high level power supply potential VDD is supplied is provided on the lower side thereof. Impurities are doped so that the N-type transistor Tr5 is formed on the upper side in the drawing while the P-type transistor Tr6 is formed on the lower side. As described above, the input terminal IN_{INV} is connected to the gates G5 and G6 of the N-type transistor Tr5 and the P-type transistor Tr6. The standard cell 280 also has a metal wire 281 for connecting the source of the N-type transistor Tr5 to the ground potential GND, a metal wire 282 for connecting the source of the P-type transistor Tr6 to the high level power supply potential VDD, and a metal wire 283 for connecting the drain of the N-type transistor Tr5 to the drain of the P-type transistor Tr6. Note that the output terminal OUT is connected to the metal wire 283, though it is not shown in the drawing for simplicity.

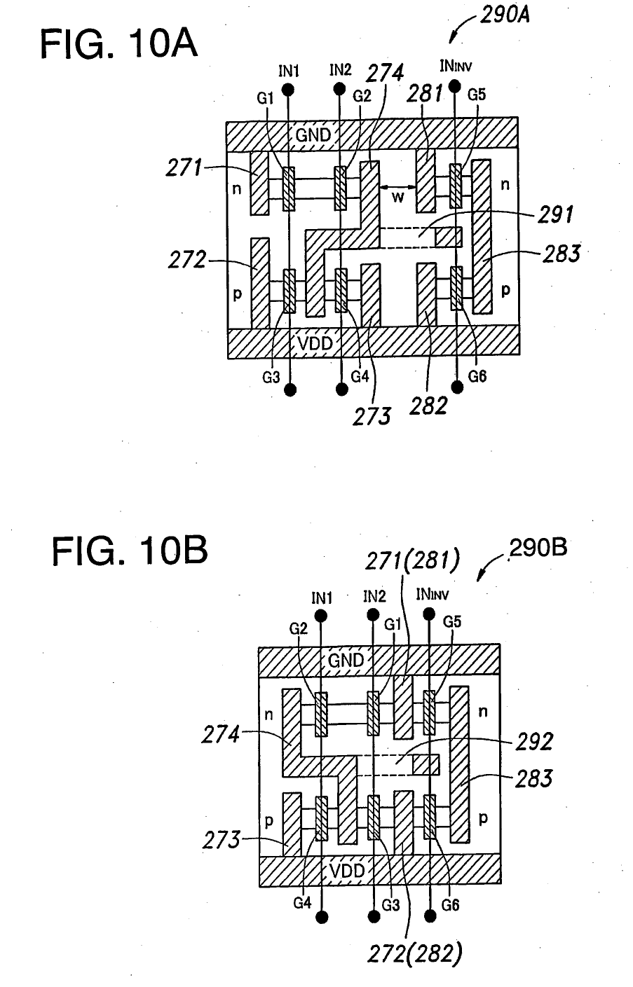

FIG. 10A shows a composite cell 290A obtained by combining the NAND gate standard cell 270A shown in FIG. 9A and the inverter standard cell 280 shown in FIG. 9C, which realizes a standard cell having the circuit configuration shown in FIG. 8B. In FIG. 10A, the same portion as that shown in FIGS. 9A and 9B is denoted by the same reference numeral, and is not described in detail. As shown by a dashed line in FIG. 10A, the composite cell 290A has an additional wire 291 for connecting the wire 274 inputted with a signal from the NAND gate standard cell 270A to the input terminal IN_{INV} of the inverter standard cell 280. If such an additional wire 291 is formed on the same layer as the metal wires included in the standard cells 270A and 280 before composition, a part of the metal wires (in this case, the metal wire 281 in the standard cell 280) included in the standard cells 270A and 280 before composition may be removed so as not to interfere the additional wire 291. Alternatively, the additional wire 291 may be formed on a different layer and connected to the wire 274 in the cell 270A and the input terminal IN_{INV} of the cell 280 through a contact hole (not shown). The connection between the two logic gates (circuit components) is thus achieved with the wire 291 inside the cell without requiring an external wire. Accordingly, by using the composite cell 290A in the formation of the semiconductor integrated circuit, the length of the wires in the entire semiconductor integrated circuit can be made shorter, and reduction in wire capacitance and improvement in operating speed (frequency) are achieved.

In the composite cell 290A, the distance w between the wiring 274 for the NAND gate and the wiring 281 for the inverter is shorter than the sum of the distance x between the wiring 274 and the side of the NAND gate standard cell 270A before composition and the distance y between the wiring 281 and the side of the inverter standard cell 280 before the composition. Accordingly, the area of the composite cell 290A is smaller than the total area of the standard cells 270A and 280 before composition. Thus, the use of the composite cell 290A can reduce the layout area of the entire semiconductor integrated circuit.

FIG. 10B shows a composite cell 290B obtained by combining the NAND gate standard cell 270B shown in FIG. 9B and the inverter standard cell 280 shown in FIG. 9C, which realizes a standard cell having the circuit configuration shown in FIG. 8B. In FIG. 10B, the same portion as that shown in FIGS. 9B and 9C is denoted by the same reference numeral, and is not described in detail. In the composite cell 290B, the pattern of the NAND gate standard cell 270B partially overlaps the pattern of the inverter standard cell 280. More specifically, the metal wires 271 and 272 in the standard cell 270B overlap the metal wires 281 and 282 in the standard cell 280, respectively. As a result, the cell area is considerably reduced. In this case, the wire 274 of the NAND gate (i.e., output of the NAND gate) and the input terminal IN_{INV} of the inverter are connected in the composite cell 270B with an additional wire 292 that is not included in the standard cells 270B and 280 before composition, and thus an external wire is not required.

### Embodiment Mode 2

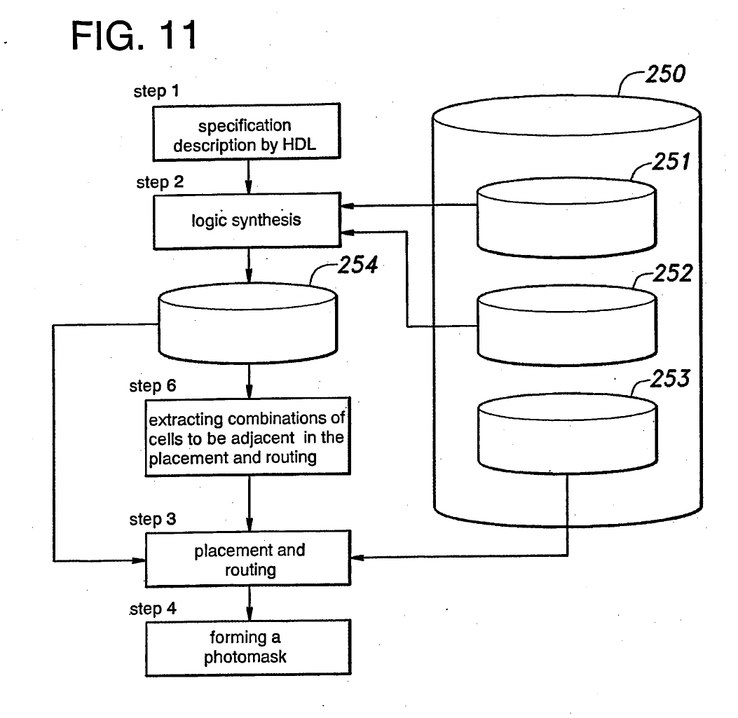

FIG. 11 is a flow chart showing a second embodiment mode of a designing method of a semiconductor integrated circuit in accordance with the invention. In this embodiment mode also, similarly to the conventional designing method, functional design of a semiconductor integrated circuit is performed using HDL (Hardware Description Language) in step 1. Then, in step 2, logic synthesis is performed using standard cells stored in the cell library 250, and the netlist 254 is generated.

The designing method of a semiconductor integrated circuit in accordance with this embodiment mode has, before the placement and routing in step 3, a step (step 6) of extracting combinations of cells that are to be adjacent to each other in the placement and routing. The combinations of cells that are to be adjacent to each other in the placement and routing may be extracted in the same manner as the combinations of cells to be composed in accordance with the Embodiment Mode 1 shown in FIG. 4.

In step 3, while referring to the cell layout information 253 stored in the cell library 250, automatic placement and routing of cells is performed so that the combinations of cells extracted in step 6 are adjacent to each other. Then, in step 4, a photomask used in manufacturing steps of the semiconductor integrated circuit is formed to achieve the cell placement and routing determined in step 3.

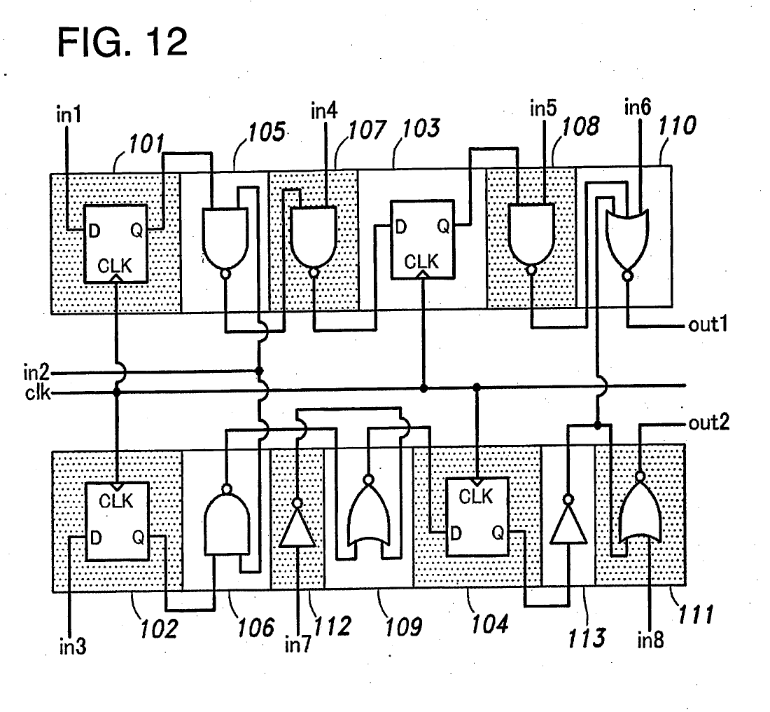

FIG. 12 is a schematic view showing an example of a cell layout obtained by applying the designing method of a semiconductor integrated circuit sown in FIG. 11 to the circuit shown in FIG. 2. In FIG. 12, the flip flop cells 101, 102 and 103 are disposed to be adjacent to the NAND gate cells 105, 106 and 108 respectively. Differently from the case (FIG. 6) where the flip flop cells 101, 102 and 103 are combined with the NAND gate cells 105, 106 and 108 respectively, connection between these cells is performed with external wires, though the length of the wires can be made shorter and wire capacitance and layout area can be reduced as compared to the case shown in FIG. 3, where the cells are not adjacent to each other.

### Embodiment

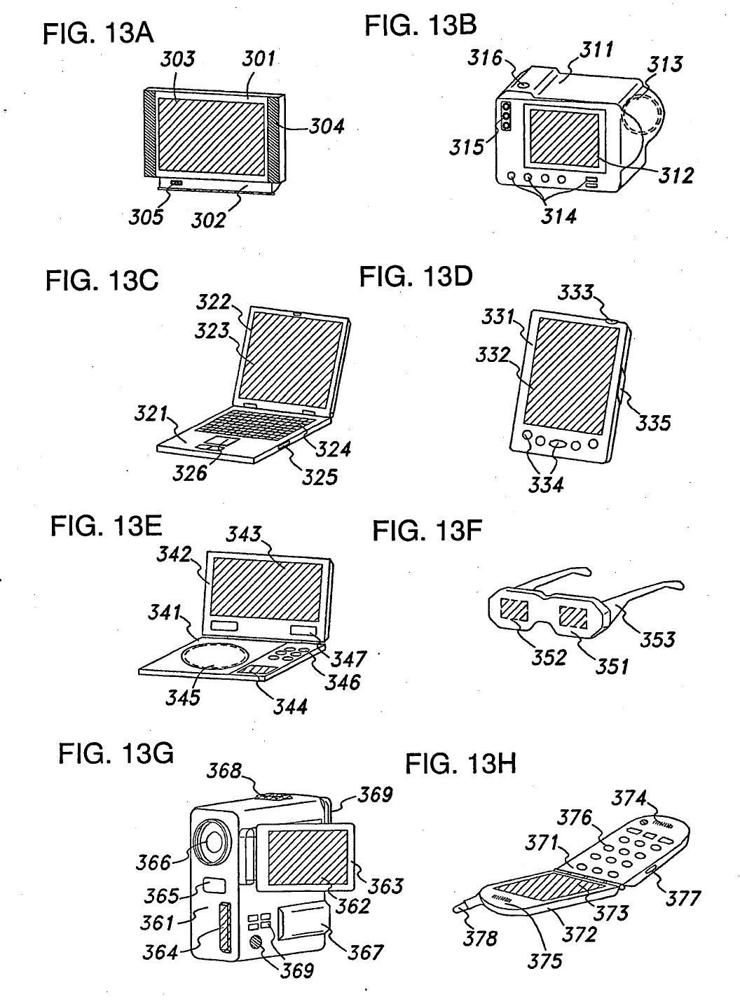

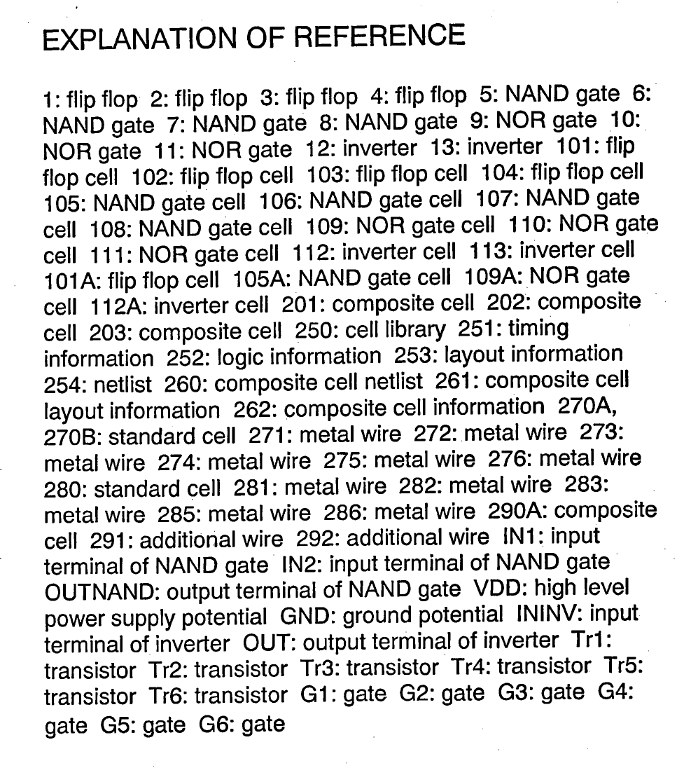

The invention can be applied to electronic apparatuses such as a desktop, a floor standing, or a wall mounted display, a video camera, a digital camera, a goggle type display, a navigation system, an audio reproducing device (car audio set, audio component set and the like), a computer, a game machine, a portable information terminal (mobile computer, mobile phone, portable game machine, electronic book and the like), and an image reproducing device provided with a recording medium (specifically, a device that reproduces moving images and still images stored in a recording medium such as a Digital Versatile Disc (DVD) and that has a display for displaying the reproduced images). Specific examples of these electronic apparatuses are shown in FIGS. 13A to 13H.

FIG. 13A shows a desktop, a floor standing, or a wall mounted display having a housing 301, a support base 302, a display portion 303, a speaker portion 304, a video input terminal 305 and the like. Such a display may be used as a display device for information display such as for personal computers, television broadcast reception, and advertisement display. The semiconductor integrated circuit and the designing method thereof in accordance with the invention may be used to realize various functional circuits included in the display. As a result, functional circuits with high operating frequency and low power consumption can be provided by reducing the wire capacitance and layout area thereof, and such functional circuits can be designed effectively. The functional circuits to which the invention can be applied include, for example, a CPU (Central Processing Unit), an image processing circuit, an audio processing circuit, a memory and the like. Note that the semiconductor integrated circuit in accordance with the invention may be formed over an IC (Integrated Circuit) chip (e.g., LSI (Large Scale Integration) chip, a VLSI (Very Large Scale Integration) chip and the like), or may be constituted by thin film transistors (TFTs) over an insulating substrate such as a glass substrate. When the semiconductor integrated circuit realizing various functional circuits is constituted by thin film transistors over the same substrate as the display portion 303, the display having the display portion with low price, thin shape, low power consumption, and high definition can be provided.

FIG. 13B shows a digital camera having a main body 311, a display portion 312, an image receiving portion 313, operating keys 314, an external connecting port 315, a shutter 316 and the like. The semiconductor integrated circuit and the designing method thereof in accordance with the invention may be used to realize various functional circuits included in the digital camera. As a result, functional circuits with high operating frequency and low power consumption can be provided by reducing the wire capacitance and layout area thereof, and such functional circuits can be designed effectively. The functional circuits to which the invention can be applied include, for example, a CPU, an image processing circuit, an audio processing circuit, a memory and the like. Note that the semiconductor integrated circuit in accordance with the invention may be formed over an IC chip (e.g., LSI chip, VLSI chip and the like), or may be constituted by thin film transistors (TFTs) over an insulating substrate such as a glass substrate. When the semiconductor integrated circuit realizing various functional circuits is constituted by thin film transistors over the same substrate as the display portion 312, the digital camera having the display portion with low price, thin shape, low power consumption, and high definition can be provided.

FIG. 13C shows a computer having a main body 321, a housing 322, a display portion 323, a keyboard 324, an external connecting port 325, a pointing mouse 326 and the like. Note that the computer includes a so-called notebook computer incorporating a CPU (Central Processing Unit), a recording medium and the like, and a so-called desktop computer that does not include a CPU, a recording medium and the like. The semiconductor integrated circuit and the designing method thereof in accordance with the invention may be used to realize various functional circuits included in the computer. As a result, functional circuits with high operating frequency and low power consumption can be provided by reducing the wire capacitance and layout area thereof, and such functional circuits can be designed effectively. The functional circuits to which the invention can be applied include, for example, a CPU, an image processing circuit, an audio processing circuit, a memory and the like. Note that the semiconductor integrated circuit in accordance with the invention may be formed over an IC chip (e.g., LSI chip, VLSI chip and the like), or may be constituted by thin film transistors (TFTs) over an insulating substrate such as a glass substrate. When the semiconductor integrated circuit realizing various functional circuits is constituted by thin film transistors over the same substrate as the display portion 323, the computer having the display portion with low price, thin shape, low power consumption, and high definition can be provided.

FIG. 13D shows a mobile computer having a main body 331, a display portion 332, a switch 333, operating keys 334, an infrared port 335 and the like. The semiconductor integrated circuit and the designing method thereof in accordance with the invention may be used to realize various functional circuits included in the mobile computer. As a result, functional circuits with high operating frequency and low power consumption can be provided by reducing the wire capacitance and layout area thereof, and such functional circuits can be designed effectively. The functional circuits to which the invention can be applied include, for example, a CPU, an image processing circuit, an audio processing circuit, a memory and the like. Note that the semiconductor integrated circuit in accordance with the invention may be formed over an IC chip (e.g., LSI chip, VLSI chip and the like), or may be constituted by thin film transistors (TFTs) over an insulating substrate such as a glass substrate. When the semiconductor integrated circuit realizing various functional circuits is constituted by thin film transistors over the same substrate as the display portion 332, the mobile computer having the display portion with low price, thin shape, low power consumption, and high definition can be provided.

FIG. 13E shows a probable image reproducing device provided with a recording medium (specifically, a DVD reproducing device), which has a main body 341, a housing 342, a first display portion 343, a second display portion 344, a recording medium (such as DVD) reading portion 345, an operating key 346, a speaker portion 347 and the like. The first display portion 343 mainly displays image information while the second display portion 344 mainly displays character information. Note that the image reproducing device provided with a recording medium includes a home game machine and the like. The semiconductor integrated circuit and the designing method thereof in accordance with the invention may be used to realize various functional circuits included in the image reproducing device. As a result, functional circuits with high operating frequency and low power consumption can be provided by reducing the wire capacitance and layout area thereof, and such functional circuits can be designed effectively. The functional circuits to which the invention can be applied include, for example, a CPU, an image processing circuit, an audio processing circuit, a memory and the like. Note that the semiconductor integrated circuit in accordance with the invention may be formed over an IC chip (e.g., LSI chip, VLSI chip and the like), or may be constituted by thin film transistors (TFTs) over an insulating substrate such as a glass substrate. When the semiconductor integrated circuit realizing various functional circuits is constituted by thin film transistors over the same substrate as the first display portion 343 or the second display portion 344, the image reproducing device having the display portion with low price, thin shape, low power consumption, and high definition can be provided.

FIG. 13F shows a goggle type display having a main body 351, a display portion 352, an arm portion 353 and the like. The semiconductor integrated circuit and the designing method thereof in accordance with the invention may be used to realize various functional circuits included in the goggle type display. As a result, functional circuits with high operating frequency and low power consumption can be provided by reducing the wire capacitance and layout area thereof, and such functional circuits can be designed effectively. The functional circuits to which the invention can be applied include, for example, a CPU, an image processing circuit, an audio processing circuit, a memory and the like. Note that the semiconductor integrated circuit in accordance with the invention may be formed over an IC chip (e.g., LSI chip, VLSI chip and the like), or may be constituted by thin film transistors (TFTs) over an insulating substrate such as a glass substrate. When the semiconductor integrated circuit realizing various functional circuits is constituted by thin film transistors over the same substrate as the display portion 352, the goggle type display having the display portion with low price, thin shape, low power consumption, and high definition can be provided.

FIG. 13G shows a video camera having a main body 361, a display portion 362, a housing 363, an external connecting port 364, a remote control receiving portion 365, an image receiving portion 366, a battery 367, an audio input portion 368, operating keys 369 and the like. The semiconductor integrated circuit and the designing method thereof in accordance with the invention may be used to realize various functional circuits included in the video camera. As a result, functional circuits with high operating frequency and low power consumption can be provided by reducing the wire capacitance and layout area thereof, and such functional circuits can be designed effectively. The functional circuits to which the invention can be applied include, for example, a CPU, an image processing circuit, an audio processing circuit, a memory and the like. Note that the semiconductor integrated circuit in accordance with the invention may be formed over an IC chip (e.g., LSI chip, VLSI chip and the like), or may be constituted by thin film transistors (TFTs) over an insulating substrate such as a glass substrate. When the semiconductor integrated circuit realizing various functional circuits is constituted by thin film transistors over the same substrate as the display portion 362, the video camera having the display portion with low price, thin shape, low power consumption, and high definition can be provided.

FIG. 13H shows a mobile phone having a main body 371, a housing 372, a display portion 373, an audio input portion 374, an audio output portion 375, an operating key 376, an external connecting port 377, an antenna 378 and the like. The semiconductor integrated circuit and the designing method thereof in accordance with the invention may be used to realize various functional circuits included in the mobile phone. As a result, functional circuits with high operating frequency and low power consumption can be provided by reducing the wire capacitance and layout area thereof, and such functional circuits can be designed effectively. The functional circuits to which the invention can be applied include, for example, a CPU, an image processing circuit, an audio processing circuit, a memory and the like. Note that the semiconductor integrated circuit in accordance with the invention may be formed over an IC chip (e.g., LSI chip, VLSI chip and the like), or may be constituted by thin film transistors (TFTs) over an insulating substrate such as a glass substrate. When the semiconductor integrated circuit realizing various functional circuits is constituted by thin film transistors over the same substrate as the display portion 373, the mobile phone having the display portion with low price, thin shape, low power consumption, and high definition can be provided.

Note that the display portions of the aforementioned electronic apparatuses may be a self luminous type using a light emitting element such as LED and organic EL in each pixel, or may use another light source such as back light as in liquid crystal displays. In the case of the self luminous type, no back light is required and thus the display portion can be made thinner than that of liquid crystal displays.

The aforementioned electronic apparatuses are becoming to be more used for a TV receptor, for displaying information distributed through a telecommunication path such as Internet and CATV (Cable Television System), and in particular used for displaying moving picture information. A self luminous type display portion is suitable for displaying moving pictures because a light emitting material such as organic EL can exhibit a remarkably high response as compared to a liquid crystal. It is also suitable for time division driving. When the luminance of the light emitting material is improved in the future, it can be used for a front type or rear type projector by magnifying and projecting light including outputted image information by a lens and the like.

Since light emitting parts consume power in a self luminous display portion, information is desirably displayed so that the light emitting parts may occupy an area as small as possible. Accordingly, if a self luminous type is used for a display portion that mainly displays character information, such as the one of a portable information terminal, particularly the one of a mobile phone or an audio reproducing device, it is preferably operated so that the character information emits light by using non-light emitting parts as background.

As set forth above, the application range of the invention is so wide that it can be applied to electronic apparatuses of all fields.

The present application is based on Japanese Priority application No. 2004-298352 filed on Oct. 13, 2004 with the Japanese Patent Office, the entire contents of which are hereby incorporated by reference.

1. A designing method of a semiconductor integrated circuit comprising:
generating a first netlist for defining a connection between a plurality of standard cells stored in a cell library base on specifications of the semiconductor integrated circuit;
analyzing the first netlist to combine at least two of the plurality of standard cells which satisfies predetermined criteria;
storing the combined two of the plurality of standard cells as a new standard cell in the cell library;
rewriting the first netlist by the new standard cell to generate a second netlist; and
performing automatic placement and routing based on the second netlist.

2. The designing method of a semiconductor integrated circuit according to claim 1, further comprising:
detecting combinations of standard cells where a first output terminal of a first standard cell is connected only to first input terminals of second to n-th (n is a natural number of two or more) standard cells; and
selecting a combination of the at least two of the plurality of standard cells that occurs a predetermined number of times or more from the detected combinations.

3. The designing method of a semiconductor integrated circuit according to claim 2, wherein the n is two.

4. The designing method of a semiconductor integrated circuit according to claim 1, wherein a combination of the at least two of the plurality of standard cells is selected from standard cells on a critical path.

5. The designing method of a semiconductor integrated circuit according to claim 1, wherein a combination is performed in the case where a layout area of the combined two of the plurality of standard cells is smaller than a predetermined area.

6. The designing method of a semiconductor integrated circuit according to claim 1,
wherein each of the plurality of standard cells stored in the cell library has a cell composition terminal on a side which is in contact with an adjacent standard cell separately from a common wiring terminal, and
wherein the new standard cell is generated by connecting the cell composition terminals of the at least two of the plurality of standard cells.

7. The designing method of a semiconductor integrated circuit, according to claim 1, wherein a wiring layer included in the new standard cell is formed separately from a wiring layer for connecting the plurality of standard cells.

8. A designing method of a semiconductor integrated circuit comprising:
generating a netlist for defining a connection between a plurality of standard cells stored in a cell library base on specifications of the semiconductor integrated circuit;
analyzing the netlist to combine at least two of the plurality of standard cells which satisfies predetermined criteria and are adjacent to each other; and
performing automatic placement and routing based on the netlist.

9. The designing method of a semiconductor integrated circuit according to any one of claims 1 or 8, wherein the semiconductor integrated circuit is a functional circuit of a display portion of an electronic apparatus.

10. The designing method of a semiconductor integrated circuit according to claim 9, wherein the functional circuit is constituted by a thin film transistor over the same substrate as the display portion.

11. A semiconductor integrated circuit comprising:
a composite cell formed by composing at least two standard cells corresponding to at least two circuit components,
wherein the composite cell has an additional wire for arbitrarily connecting the at least two circuit components, and
wherein the additional wire is not provided in the at least two standard cells.

12. The semiconductor integrated circuit according to claim 11, wherein the additional wire in the composite cell is formed over a different layer than wires provided in the at least two standard cells.

13. The semiconductor integrated circuit according to claim 11, wherein a part of the wires provided in the at least two standard cells is removed.

14. A semiconductor integrated circuit comprising:
a composite cell formed by composing at least two standard cells corresponding to at least two circuit components,
wherein each of the at least two standard cells has a cell composition terminal on a side which is in contact with an adjacent standard cell separately from a common wiring terminal, and
wherein the at least two circuit components are connected by using the cell composition terminal.

15. A semiconductor integrated circuit comprising:
a composite cell formed by composing at least two standard cells corresponding to at least two circuit components,
wherein a pattern of one of the at least two standard cells partially overlaps a pattern of the other of the at least two standard cells.

16. The semiconductor integrated circuit according to any one of claims 11, 14 or 15, wherein an area of the composite cell is smaller than a total area of the at least two standard cells.

17. The semiconductor integrated circuit according to any one of claims 11, 14 or 15, wherein the composite cell comprises one.

18. An electronic apparatus having the semiconductor integrated circuit according to any one of claims 11, 14 or 15.

19. The electronic apparatus according to claim 18, wherein the semiconductor integrated circuit is used for a functional circuit of a display portion of the electronic apparatus.

20. The electronic apparatus according to claim 19, wherein the functional circuit is constituted by a thin film transistor over the same substrate as the display portion.
